(19) United States
(12) Patent Application Publication
(10) Pub. No.: US 2009/0261487 A1
(43) Pub. Date: Oct. 22, 2009

(54) METHOD FOR MAKING OPTICAL ARTICLES

(75) Inventor: Sei-Ping Louh, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/202,586

(22) Filed: Sep. 2, 2008

(30) Foreign Application Priority Data
Apr. 16, 2008 (CN) 200810301161.9

(51) Int. Cl. B29D 11/00

(52) U.S. Cl. 264/1.7

(57) ABSTRACT

A method for making an optical article having a first optical surface and an opposite second optical surface, is provided. The method includes: providing a transparent substrate having a first surface and an opposite second surface; forming a first layer comprised of a first molding material on the first surface of the substrate; press-molding the first layer to form a first optical surface thereon; providing a supporting mold having a supporting surface conforming to the first optical surface; attaching the supporting mold to the first layer with the first optical surface in intimate contact with the supporting surface thereof; forming a second layer comprised of a second molding material on the second surface of the substrate; press-molding the second layer to form a second optical surface thereon; and removing the supporting mold to obtain an optical article including the substrate with the first and second layers at opposite sides thereof.

### BACKGROUND

1. Technical Field

The present invention relates to methods for making optical articles, and particularly, to a press-molding method for making an optical article.

2. Description of Related Art

Optical articles, such as lenses, are transparent and usually have concave or convex microstructures formed on opposite surfaces thereof. The opposite surfaces having the microstructures are called optical surfaces.

Press-molding is widely used for making large quantities of optical articles. Optical surfaces of an optical article can be formed at a same time using a press-molding machine having two opposite press-molding molds, or can be formed successively using one or two press-molding molds.

However, with the above method, the press-molding machine is expensive, and stress fractures may be generated in the microstructures of one optical surface during formation of the other optical surface.

What is needed, therefore, is a method for making an optical article, which can overcome the above shortcomings.

### SUMMARY

A method for making an optical article having a first optical surface and an opposite second optical surface, is provided. The method includes: providing a transparent substrate having a first surface and an opposite second surface; forming a first layer comprised of a first molding material on the first surface of the transparent substrate; press-molding the first layer to form a first optical surface thereon; providing a supporting mold having a supporting surface conforming to the first optical surface; attaching the supporting mold to the first layer with the first optical surface in intimate contact with the supporting surface thereof; forming a second layer comprised of a second molding material on the second surface of the transparent substrate; press-molding the second layer to form a second optical surface thereon; and removing the supporting mold to obtain an optical article including the transparent substrate with the first and second layers at opposite sides thereof.

Other advantages and novel features of the method will become more apparent from the following detailed description of embodiment when taken in conjunction with the accompanying drawings.

### BRIEF DESCRIPTION OF THE DRAWINGS

Many aspects of the method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 shows a substrate and a first layer of molding material formed on a first surface of the substrate.

FIG. 2 shows the first layer shown in FIG. 1 is press-molded into a first optical surface by a first mold having a first molding surface.

FIG. 3 shows the first optical surface shown in FIG. 2 is supported by a supporting mold and a second layer of molding material formed on a second surface of the substrate.

FIG. 4 shows an optical article with finished opposite first and second surfaces.

FIG. 5 shows formation of an interim mold.

FIG. 6 shows formation of a supporting mold.

### DETAILED DESCRIPTION OF THE EMBODIMENTS

Embodiments of the present method will now be described in detail below and with reference to the drawings.

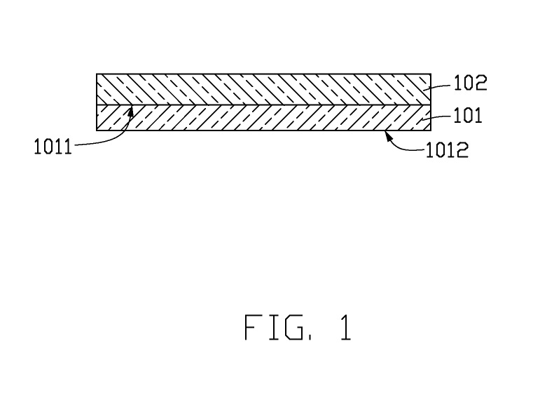

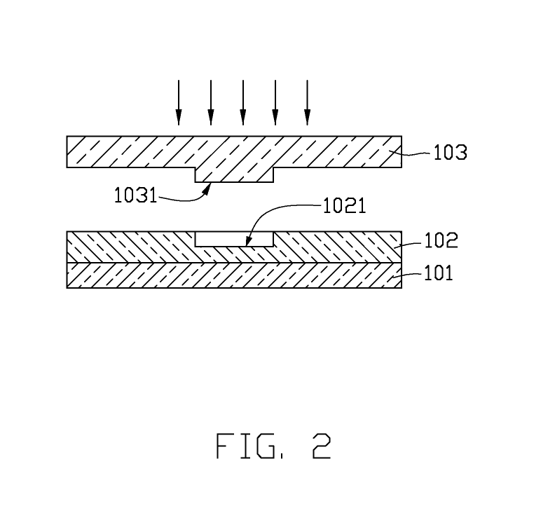

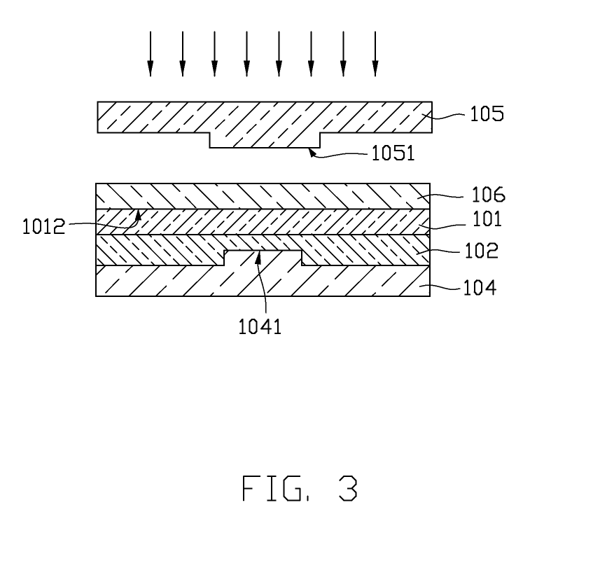

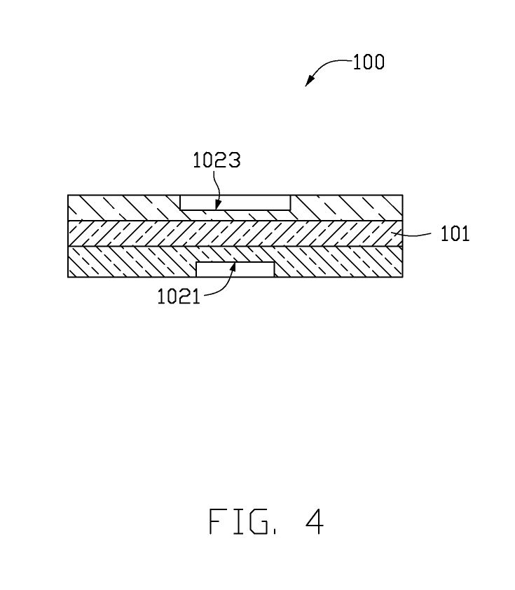

Referring to FIGS. 1 to 4, a method for making an optical article 100, is provided. The optical article 100 has a first optical surface 1021 and an opposite second optical surface 1023. Each of the first and second optical surfaces 1021, 1023 has a concave microstructure. The method includes, in no particular order:
providing a transparent substrate 101 having a first surface 1011 and an opposite second surface 1012;
forming a first layer 102 of molding material on the first surface 1011 of the transparent substrate 101;
press-molding the first layer 102 to form a first optical surface 1021 thereon;
providing a supporting mold 104 having a supporting surface 1041 conforming to the first optical surface 1021;
attaching the supporting mold 104 to the first layer 102 with the first optical surface 1021 in intimate contact with the supporting surface 1041 thereof;
forming a second layer 106 of a second molding material on the second surface 1012 of the transparent substrate 101;
press-molding the second layer 106 to form a second optical surface 1023 thereon; and
removing the supporting mold 104 to obtain the optical article 100 including the transparent substrate 101 with the first and second layers 102, 106 at opposite sides thereof.

The first and second molding material each are transparent, and can be selected from a thermosetting material or a thermoplastic material. The first and second molding material are molten when they are applied on the respective first surface 1011 and second surface 1012 of the transparent substrate 101. The first and second molding material can be the same.

In the two press-molding steps, a first mold 103 and a second mold 105 are used, respectively. The first mold 103 has a convex first molding surface 1031 to conform to the first optical surface 1021. The second mold 105 has a convex second molding surface 1051 to conform to the second optical surface 1023. The first mold 103 and the second mold 105 are both transparent to a UV light (represented as downward arrowheads), as a result, the UV light can pass through the first and second molds 103, 105 to solidify the first and second layers 102, 106.

The supporting surface 1041 of the supporting mold 104 has a same shape as that of the first molding surface 1031 of the first mold 103. The supporting surface 1041 preferably has a same material as the first optical surface 1021, such that the supporting surface 1041 can be more intimately contact with the first optical surface 1021, and the first optical surface 1021 will not be scratched by the supporting surface 1041. Due to the support of the supporting surface 1041, when a force of the second mold 105 is applied to the second layer 106, i.e., during the formation of the second optical surface 1023, stress generated in the concave microstructure of the first optical surface 1021, especially in corners of the concave microstructure of the first optical surface 1021 can be greatly reduced. Deformation of the concave microstructure of the first optical surface 1021 can be avoided in this way.

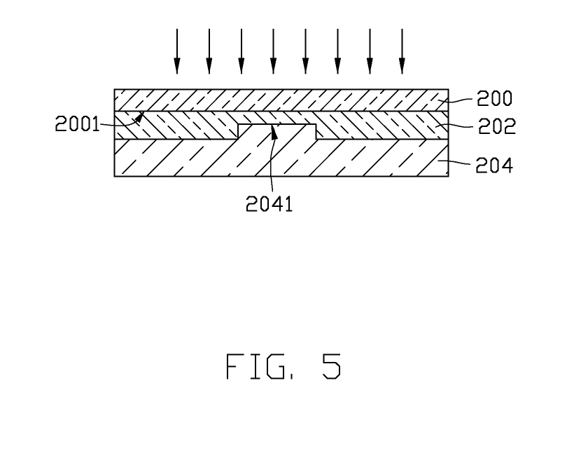

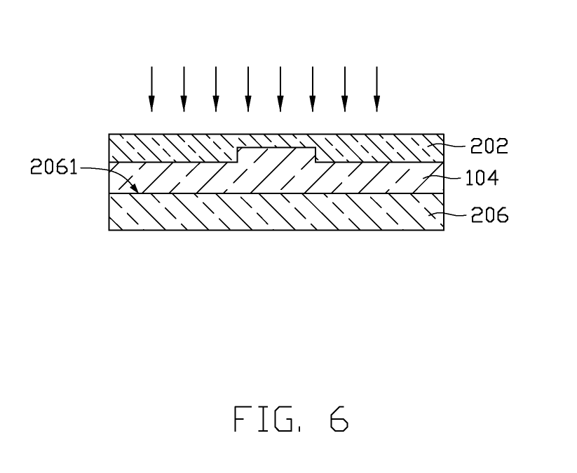

Referring to FIG. 5 to 6, the supporting mold 104 can also be formed by a press-molding method. The press-molding method for making the supporting mold 104, includes:
providing a female mold 200 and an a male mold 204, the female mold 200 having a smooth molding surface 2001, the male mold 204 having a convex molding surface 2041, the convex molding surface 2041 being the same as first molding surface 1031 of the first mold 103 and corresponding to first optical surface 1021;
forming a first interim layer comprised of a molding material on the smooth molding surface 2001 of the female mold 200;
press-molding the first interim layer using the convex molding surface 2041 of the male mold 204 to form an interim mold 202;
providing a substrate 206 having a smooth surface 2061;
forming a second interim layer comprised of a molding material on the substrate 206, the molding material of the second interim layer being the same as that of the first optical surface 1021;
press-molding the second interim layer using the interim mold 202 to form the supporting mold 104.

In the above steps for forming the interim mold 202 and the supporting mold 104, the molding material of the interim mold 202, the female mold 200, and the male mold 204 are also transparent. A UV light (represented as downward arrowheads) is also used to solidify the interim mold 202 and the supporting mold 104. The molding material of the interim mold 202 can be the same as or different from that of the first optical surface 1021. The female mold 200 and the male mold 204 can exchange their positions.

Alternatively, the supporting mold 104 can be preformed using an injection molding method.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

1. A method for making an optical article having a first optical surface and an opposite second optical surface, comprising:
providing a transparent substrate having a first flat surface and an opposite second flat surface;
forming a first layer comprised of a first molding material on the first flat surface of the transparent substrate;
press-molding the first layer to form a first optical surface thereon;
providing a supporting mold having a supporting surface conforming to the first optical surface;
attaching the supporting mold to the first layer with the first optical surface in intimate contact with the supporting surface;
forming a second layer comprised of a second molding material on the second flat surface of the transparent substrate;
press-molding the second layer to form a second optical surface thereon; and
removing the supporting mold to obtain an optical article including the transparent substrate with the first and second layers at opposite sides thereof.

2. The method of claim 1, wherein the supporting mold is comprised of the first molding material.

3. The method of claim 1, wherein the first layer is pressed using a first mold having a first molding surface to form the first optical surface, the supporting surface having a same shape as that of the first molding surface.

4. The method of claim 3, wherein the first mold is transparent to a given light, and the given light is applied onto the first mold to solidify the first layer during formation of the first optical surface.

5. The method of claim 1, wherein the second layer is pressed using a second mold having a second molding surface to form the second optical surface.

6. The method of claim 5, wherein the second mold is transparent to a given light, and the given light is applied onto the second mold to solidify the second layer during formation of the second optical surface.

7. The method of claim 1, wherein the supporting mold is formed using a press-molding method or by an injection molding method.

8. The method of claim 1, wherein the first molding material is the same as the second molding material.
